(19) United States
(12) Patent Application Publication
(10) Pub. No.: US 2013/0226871 A1
(43) Pub. Date: Aug. 29, 2013

(54) METHOD AND APPARATUS FOR COPYING A FILE

(71) Applicant: Piotr Konstanty SARNOWSKI, Warsaw (PL)

(72) Inventor: Piotr Konstanty SARNOWSKI, Warsaw (PL)

(73) Assignee: SAMSUNG ELECTRONICS CO., LTD., Gyeonggi-do (KR)

(21) Appl. No.: 13/597,493

(22) Filed: Aug. 29, 2012

(30) Foreign Application Priority Data
Aug. 29, 2011 (KR) 10-2011-0086422

(51) Int. Cl. G06F 3/06

(52) U.S. Cl. CPC G06F 3/065
USPC 707/637

(57) ABSTRACT

A method and apparatus perform file copying, including selecting a plurality of files, which a first terminal desires to copy, and temporarily storing the selected files in a second terminal; identifies whether there is a file collision between the first terminal and the second terminal before performing a copying of the temporarily stored files; generates a queue, which is a copying process order of the temporarily stored files, according to the existence of the file collision; copies the temporarily stored files using the queue; and displays a copying process speed of each file when a copying of queued files is performed.

### CLAIM OF PRIORITY

This application claims priority under 35 U.S.C. §119(a) to a Korean Patent Application entitled “Method and Apparatus for Copying File” filed in the Korean Intellectual Property Office on Aug. 29, 2011 and assigned Serial No. 10-2011-0086422, the contents of which are incorporated herein by reference.

### BACKGROUND OF THE INVENTION

1. Field of the Invention The present invention relates to file copying between homogeneous terminals or heterogeneous terminals.

2. Description of the Related Art

FIGS. 1A and 1B illustrate examples of a display screen of a terminal, such as a computer, in which file copying is performed according to the prior art. In general, when file copying is performed through a wired and/or wireless connection between terminals, copies of subsequent files are sequentially started/ended after a starting/ending of the copying of each file, which is being copied, is completed in a process of copying a plurality of files as shown in FIG. 1A.

In another case, as shown in FIG. 1B, it takes more than 4 minutes to copy two files. Also, when a user copies a large capacity file, there is a possibility of generating an error and a collision during the copying, so that a problem may occur in which the user may be required to attempt to copy the file again from the beginning when the first copying attempt is stopped due to the error.

### SUMMARY OF THE INVENTION

Accordingly, the present invention has been made to solve the above-stated problems occurring in the prior art, and an aspect of the present invention is to improve file copying speed by simultaneously performing file copying between homogeneous terminals or heterogeneous terminals using disk array technology in a file copying process.

In accordance with an aspect of the present invention, there is provided a method of performing file copying, including selecting a plurality of files, which a first terminal desires to copy, and temporarily storing the selected files in a second terminal; identifying whether there is a file collision between the first terminal and the second terminal before performing the copying of the temporarily stored files; generating a queue, which is a copying process order of the temporarily stored files, according to the existence of the file collision; copying the files; and displaying a copying process speed of each file when the copying of queued files is performed.

In accordance with another aspect of the present invention, there is provided an apparatus for performing file copying, including a storage unit for storing a plurality of files and version states of the files related to copies of the files; a file collision identifier for identifying the version state of each file stored in the storage unit and changing the version state of each file into a collision state indicating that there is a collision; and a controller for controlling a the copying of files, such that a plurality of files, which are desired to be copied, are selected and temporarily stored, a queue, which is a copying process order, is generated according to the existence of a collision of the temporarily stored files, copying the files, and a copying process speed for each file is output when the copying of a queued file is performed.

### BRIEF DESCRIPTION OF THE DRAWINGS

The above and other aspects, features and advantages of the present invention will be more apparent from the following detailed description taken in conjunction with the accompanying drawings, in which:

FIGS. 1A and 1B illustrate examples of a screen in which a file copying is performed according to the prior art;

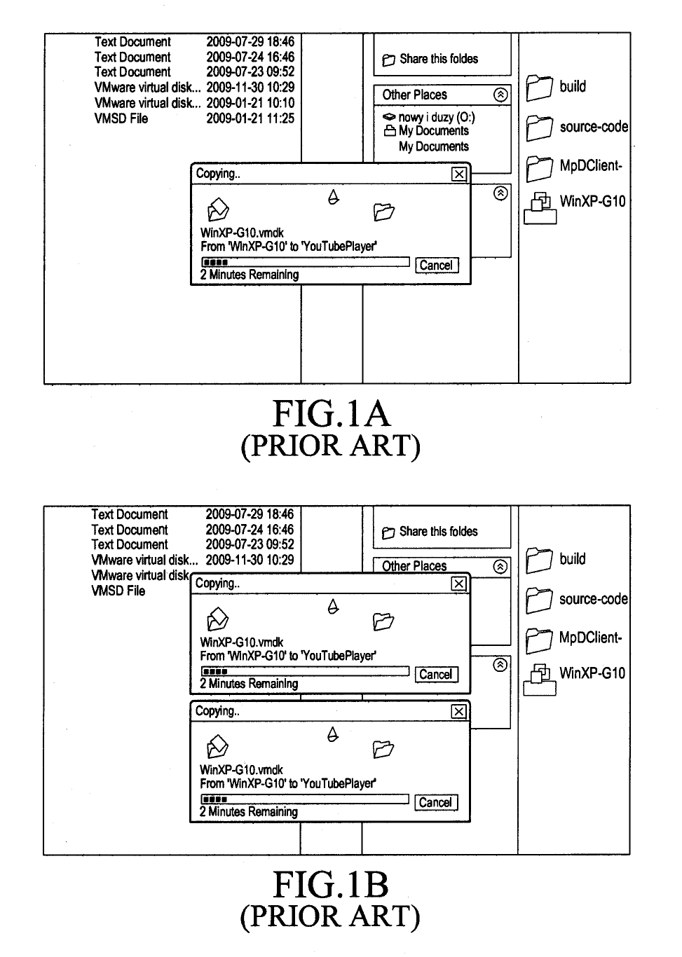

FIG. 2 is a flowchart of a file service and copying method according to an embodiment of the present invention;

FIG. 3 is a block diagram illustrating an example implementation of a file copying apparatus according to an embodiment of the present invention; and

FIG. 4 illustrates an example of a screen of a file copying process between terminals according to an embodiment of the present invention.

### DETAILED DESCRIPTION OF THE INVENTION

Hereinafter, preferred embodiments of the present invention will be described with reference to the accompanying drawings. This invention may, however, be embodied in many different forms and should not be construed as limited to the exemplary embodiments set forth herein. In the following description, a detailed explanation of known related functions and constructions may be omitted to avoid unnecessarily obscuring the subject matter of the present invention. Also, terms described herein, which are defined considering the functions of the present invention, may be implemented differently depending on user and operator's intention and practice. Therefore, the terms should be understood on the basis of the disclosure throughout the specification. The principles and features of this invention may be employed in varied and numerous embodiments without departing from the scope of the invention.

Furthermore, although the drawings represent exemplary embodiments of the invention, the drawings are not necessarily to scale and certain features may be exaggerated or omitted in order to more clearly illustrate and explain the present invention.

Among the terms set forth herein, a terminal refers to any kind of device capable of processing data which is transmitted or received to or from any external entity. The terminal may display icons or menus on a screen to which stored data and various executable functions are assigned or mapped. The terminal may include a computer, a notebook, a tablet PC, a mobile device, and the like.

Among the terms set forth herein, a screen refers to a display or other output devices which visually display information to the user, and which optionally are capable of receiving and electronically processing tactile inputs from a user using a stylo, a finger of the user, or other techniques for conveying a user selection from the user to the output devices.

The present invention relates to a file copying. More specifically, the present invention is to improve file copying speed between homogeneous terminals or heterogeneous terminals. For this purpose, the present invention provides a technology implementing the following processes: a first terminal selects files, a second terminal temporarily stores the selected files before performing copying of the selected files, any collision between the first and second terminals is identified, a copying process priority is set for collidable files and the collidable files are copied according to the set copying process priority, a queue, which is a copying process order, is generated for non-collidable files, such that the non-collidable files are copied at the same time, and a copying process speed for each file is displayed when a queued file is copied. As a result, it is possible to identify a copying state of each file and a fast copying service may be provided since copies for a plurality of large capacity files are performed at the same time.

Further, it is preferred that a terminal according to embodiments of the present invention corresponds to a terminal which can communicate with a server through a network, and it is apparent that the terminal may be implemented by any types of information and communication devices and multimedia devices such as a digital broadcasting terminal, a Personal Digital Assistant (PDA), a smart phone, a 3G terminal, for example, an IMT-2000 (International Mobile Telecommunication 2000) terminal, a WCDMA (Wideband Code Division Multiple Access) terminal, a GSM/GPRS (Global System for Mobile communication General Packet Radio Service) terminal, and a UMTS (Universal Mobile Telecommunication Service) terminal, and applications of them.

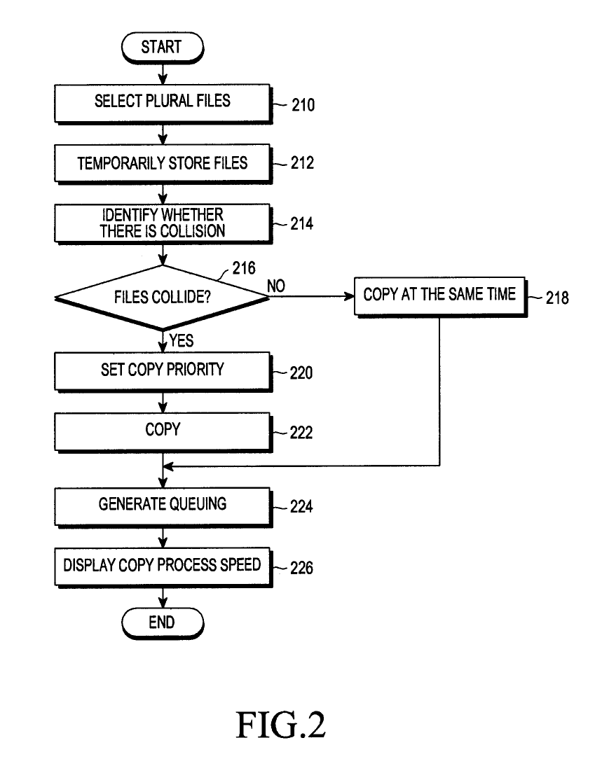

Hereinafter, a file copying method according to an embodiment of the present invention will be described in detail with reference to FIG. 2.

FIG. 2 is a flowchart of a file service and copying method according to an embodiment of the present invention.

First, a first terminal selects at least one file, for example, based on instructions input by a user to the first terminal, identifying which files are desired to be copied, in step 210, and a second terminal temporarily stores the selected file in step 212.

Here, the second terminal reads the file, which is desired to be copied, from the first terminal and writes the read file. The first terminal providing the file, which is desired to be copied, may correspond to a neighboring terminal of the second terminal, or alternatively, the first terminal may be remotely located relative to the second terminal. The first terminal may be a terminal homogenous to, that is, identical in configuration to, the second terminal, or alternatively may be a terminal heterogeneous to, that is, different in configuration from the second terminal. The file copying may be performed in an internal area of the second terminal. Alternatively, the first and second terminals may be sub-units of a third terminal, with the first and second terminals copying files between each other within the third terminal.

Further, in the step 212 of temporarily storing the files in the second terminal, the selected files may be, in an exemplary implementation, divided into a plurality of blocks in a disk array or other known types of memory devices, and the divided blocks are dispersively stored in the disk array.

In step 214, any collision of a file reading/writing between the first terminal and the second terminal is identified before the file temporarily stored in the second terminal is copied.

More specifically, when a predetermined file is copied from the first terminal to the second terminal, each file's version state for the copy, that is, a version state of each file in the first terminal is stored, and a property of each stored file is detected. And then, the method attempts to access a current version of the file and a version in a stored area, which is a version on the second terminal, and in such attempts, the method identifies whether there is a file collision between the first terminal and the second terminal. A result of the identification of a file collision may include a version state between the first and second terminals being labeled the “same”, or one version being labeled a “latest version” or a “former version” of another version.

As a result of the identification of the file collision in step 216, the method proceeds to step 220 to copy the collidable files according to a set or predetermined copying priority. Otherwise, the method proceeds to step 218 to have non-collidable files copied at the same time.

Referring back to step 220, in setting a copying priority of the collidable files, the method stores, for each collidable file, a version state related to a copy of a corresponding file, changes the version state of the file into a collision state indicating that there is a collision, and solves the collision state of each collidable file, and then the method proceeds to step 222 to copy the collidable files.

The copy priority for the collidable files may be set in step 220 according to an order of files by which collisions are solved or may be randomly set by a user.

In addition, the method detects for any request for the file copying in step 222 associated with the file selected by the first terminal or associated with the temporarily stored file in step 212. When the request is associated with the temporarily stored file, to the method proceeds step 224 and a queue of such file copying requests is automatically generated.

The queue means a file processing queue and refers to a copy processing order for sequentially coping the requested files in the present invention.

In step 226, a copying process speed of each file is displayed, for example, on a respective screen of the first terminal when the file queued in step 224 is copied.

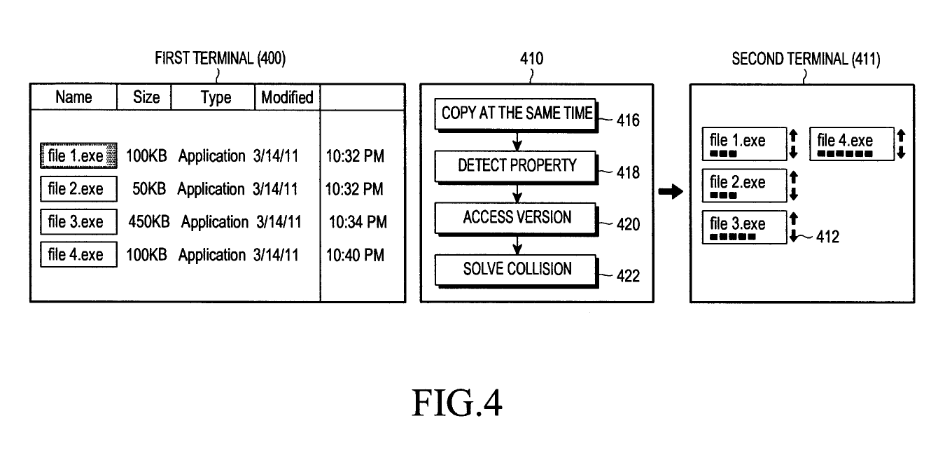

For example, in a graphical display shown by a display unit 312, as described herein, implementation of the method of the invention is shown in FIG. 4, referring to the operations of steps 210 to 226, in which a first terminal 400 selects a plurality of files (file 1, file 2, file 3, file 4, . . . ), which are desired to be copied in the copying procedure 410 having the steps 416-422, and a second terminal 411 stores the selected files.

More specifically, the files (file 1, file 2, file 3, file 4,...), which are read and copied from the first terminal 400 to the second terminal 411, are temporarily stored in step 416 and at least one property; that is, a parameter associated with each of the temporarily stored files is detected in step 418. Further, access is performed in step 420 for a current version of each file and a version of the second terminal 411, and any collision for each file is solved in step 422.

The files in which collisions are solved are queued and their copying process speeds are displayed, respectively as shown in a display unit of the second terminal 411.

At this time, a user can set a copying process priority for each file by using arrows 412 displayed in the display unit 312 of the second terminal 411, with such arrows being actuatable icons on a graphic user interface (GUI) displayed to a user through the display unit 312 for controlling the copying process using a mouse or other input devices for selecting and actuating the arrows 412.

Meanwhile, the files, which may not collide with other files, are copied at the same time, and the copies can be implemented by dispersively loading the respective non-collision files at the same time through a disk array or other known memory devices.

So far, the file copying method according to a preferred embodiment of the present invention has been described.

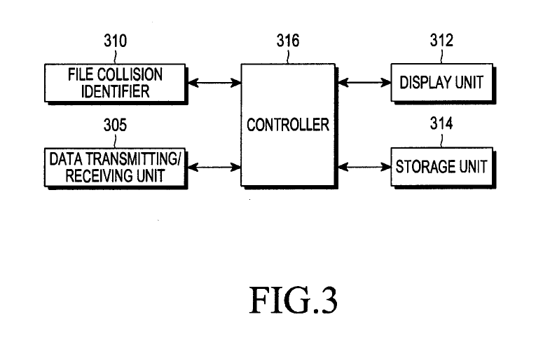

Hereinafter, a file copying apparatus according to a preferred embodiment of the present invention will be described in detail with reference to FIG. 3.

FIG. 3 is a block diagram illustrating an example implementation of the file copying apparatus according to an embodiment of the present invention.

Referring to FIG. 3, the file copying apparatus includes a data transmitting/receiving unit 305, a file collision identifier 310, a display unit 312, a controller 316, and a storage unit 314.

The data transmitting/receiving unit 305 performs file copying with an external terminal connected through a wired and/or wireless connection or communication channel.

The storage unit 314 stores, under the control of the controller 316, a plurality of files, version states of the files related to the copy of the file, and a copying process priority.

The file collision identifier 310 identifies a version state of a file stored in the storage unit 314 and changes a version state of a file having a collision into a collision state indicating that there is a collision.

More specifically, when a predetermined file is first copied from the first terminal 400 to the second terminal 411, the file collision identifier 310 detects each file's former version state related to the copying, that is, a property of a stored file from the storage unit storing a version state from the first terminal and performs an access of the current version of the file and a version of a stored area, which is a version from the second terminal, so that any file collision is identified between the first terminal and the second terminal. A result of the identification of the file collision may include states in which version states between the first and second terminals are labeled the “same”, or one version is labeled a “latest version” or a “former version” of another version.

The display unit 312 displays a copying state and a copying process speed of each file queued through the controller 316 using, for example, a Graphic User Interface (GUI).

The controller 316 controls the copying process such that plural files, which are desired to be copied, are selected and the selected files are temporarily 5 stored. Further the controller 316 controls the copying process such that a queue, which is a copy processing order, is generated according to the existence of a collision of the temporarily stored files before the file copying is performed. In addition, a copying process speed of each file queued in the copying process is displayed by the display unit 312.

At this time, the selected files are divided into a plurality of blocks and dispersively stored through a disk array or other known memory devices. As a result, the files are temporarily stored.

Further, the controller 316 sets a copying process priority of files, which may collide with other files, identified through the file collision identifier 310, performs the copying according to the set priority, and processes the files such that non-collision files, which may not collide with other files, are copied at the same time.

The non-collision files are controlled such that they are dispersively loaded through a disk array or other known memory devices, which may be implemented in the storage unit 314, to be copied at the same time.

The controller 316 detects whether a request for performing file copying is generated and associated with the selected file by the first terminal or the temporarily stored file, and controls the file copying such that a queue is automatically generated when the request is generated and associated with the temporarily stored file.

According to the present invention, an advantageous effect in speed and efficiency occurs by providing a fast copying service when a plurality of large capacity files are copied since the files are copied at the same time.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the present invention has been shown and described with reference to certain exemplary embodiments and drawings thereof, it will be understood by those skilled in the art that various changes in form and details may be made therein without departing from the spirit and scope of the invention as defined by the appended claims.

What is claimed is:

1. A method of performing file copying, comprising:
selecting a plurality of files, which a first terminal desires to copy, and temporarily storing the selected files in a second terminal;
identifying whether there is a file collision between the first terminal and the second terminal before performing the copying of the temporarily stored files;
generating a queue, which is a copying process order of the temporarily stored files, according to the existence of the file collision;
copying the selected files to the second terminal using the queue; and
displaying a copying process speed of each file when the copying of queued files is performed.

2. The method as claimed in claim 1, wherein in generating the copying process order, a copying process priority is set for collidable files and the collidable files are copied according to the set copying process priority, and non-collidable files are copied at the same time.

3. The method as claimed in claim 1, further comprising:
if a request is detected for performing the file copying generated in the second terminal with the request associated with the files selected by the first terminal or the files temporarily stored in the second terminal, automatically generating the queue when the request is associated with the files temporarily stored in the second terminal. 25

4. The method as claimed in claim 1, wherein the file copying is performed within a third terminal which includes the first and second terminals.

5. The method as claimed in claim 1, wherein for the collidable files, a version state of each file related to a copy of the corresponding file is stored, the version state of each file is changed into a collision state indicating there is a collision, and the file collision is solved.

6. The method as claimed in claim 1, wherein in temporarily storing the selected files in the second terminal, the selected files are divided into a plurality of blocks in a memory device, and the divided blocks are dispersively stored.

7. The method as claimed in claim 2, wherein the non-collidable files copied at the same time are dispersively loaded through a memory device.

8. An apparatus for performing file copying, comprising:
a storage unit for storing a plurality of files and version states of the files related to copies of the files;
a file collision identifier for identifying a version state of each file stored in the storage unit and changing the version state of each file into a collision state indicating that there is a collision; and
a controller for controlling the file copying, such that a plurality of files, which are desired to be copied, are selected and temporarily stored, a queue, which is a copying process order, is generated according to the existence of a collision of the temporarily stored files, the file copying is performed using the queue, and a copying process speed for each file is output when copying of a queued file is performed.

9. The apparatus as claimed in claim 8, wherein the controller controls the file copying such that a copying process priority is set for collidable files and the collidable files are copied according to the set copying process priority, and non-collidable files are copied at the same time.

10. The apparatus as claimed in claim 8, wherein, after detecting whether a request for performing a copying is associated with the files selected by a first terminal or the temporarily stored files, the controller automatically generates a queue when the request is generated and associated with the temporarily stored files.

11. The apparatus as claimed in claim 8, wherein the controller divides the files selected by the first terminal into a plurality of blocks through a memory device and dispersively stores the divided blocks in the storage unit.

12. The apparatus as claimed in claim 9, wherein the controller controls the file copying such that each of the non-collidable files is dispersively loaded through a memory device and is copied at the same time.

13. The method as claimed in claim 1, wherein the first and second terminals are homogeneous terminals.

14. The method as claimed in claim 1, wherein the first and second terminals are heterogeneous terminals.

15. The method as claimed in claim 6, wherein the memory device is a disk array.

16. The method as claimed in claim 7, wherein the memory device is a disk array.

17. The apparatus as claimed in claim 8, wherein the first and second terminals are homogeneous terminals.

18. The apparatus as claimed in claim 8, wherein the first and second terminals are heterogeneous terminals.

19. The apparatus as claimed in claim 11, wherein the memory device is a disk array.

20. A method of performing file copying, comprising:
selecting a plurality of files, which a first terminal desires to copy, and temporarily storing the selected files in a second terminal;
identifying whether there is a file collision between the first terminal and the second terminal before performing the copying of the temporarily stored files;
generating a queue, which is a copying process order of the temporarily stored files, according to the existence of the file collision; and
copying the selected files to the second terminal using the queue.
